(19) United States
(12) Patent Application Publication
(10) Pub. No.: US 2025/0115458 A1
(43) Pub. Date: Apr. 10, 2025

(54) ELEVATOR SYSTEM INSTALLATION VERIFICATION

(71) Applicant: Otis Elevator Company, Farmington, CT (US)

(72) Inventors: Jan Ruhnke, Berlin (DE); Stephan Böttcher, Berlin (DE)

(21) Appl. No.: 18/906,557

(22) Filed: Oct. 4, 2024

(30) Foreign Application Priority Data
Oct. 6, 2023 (EP) 23202191.5

(51) Int. Cl. B66B 1/34; B66B 9/00

(52) U.S. Cl. CPC B66B 1/3407; B66B 1/3492; B66B 9/00

(57) ABSTRACT

A method for verifying installation of an elevator system, including: moving an elevator car (103) to a given landing (125) of a plurality of landings (125) and stopping at the given landing (125); recording an absolute position of the elevator car (103) at a landing position indicator (318) corresponding to the given landing (125); checking for an alignment of the elevator car (103) with the landing doors (126) of the given landing (125); moving the elevator car (103) to another landing (125) of the plurality of landings (125) and stopping at the other landing (125). These steps are repeated for all landings (125) to generate a landing table, in which the absolute position recorded at each landing position indicator (318) is associated with a verified or unverified alignment of the elevator car (103) with the landing doors (126) at each landing (125).

### FOREIGN PRIORITY

This application claims priority to European Patent Application No. 23202191.5, filed Oct. 6, 2023, and all the benefits accruing therefrom under 35 U.S.C. § 119, the contents of which in its entirety are herein incorporated by reference.

### BACKGROUND OF THE INVENTION

The examples described herein relate generally to elevator systems, and more particularly, to reducing the installation time for an elevator system. There is disclosed a method for verifying installation of an elevator system.

An elevator system typically includes a plurality of belts or ropes (load bearing members) that move an elevator car vertically within a hoistway or elevator shaft between a plurality of elevator landings. During installation of an elevator system, the elevator system must learn the location of all of the landings, and where the elevator car must stop in order to be level with these landings. Determination of the position of the elevator car within the elevator shaft relative to the landings is therefore essential for levelling of the elevator, to ensure safe loading/unloading of the elevator. Accordingly, it is advantageous to reduce the time taken for levelling of the elevator for faster elevator installation.

### SUMMARY OF THE INVENTION

According to some examples, a method for verifying installation of an elevator system is provided, the elevator system comprising; an elevator shaft comprising a plurality of landings, each landing comprising landing doors, a plurality of landing position indicators positioned within the elevator shaft, each landing position indicator corresponding to a landing; an elevator car arranged to move along the elevator shaft; an elevator drive arranged to move the elevator car; and an absolute position reference system for providing an absolute position of the elevator car in the elevator shaft; the method comprising: i) moving the elevator car to a given landing of the plurality of landings and stopping at the given landing; ii) recording the absolute position of the elevator car at the landing position indicator corresponding to the given landing; iii) while the elevator car is stopped at the given landing, checking for an alignment of the car doors with the landing doors of the given landing; iv) moving the elevator car to another landing of the plurality of landings and stopping at the other landing; v) repeating steps i)-iv) to move the elevator car to each landing of the plurality of landings; and vi) generating a landing table in which the absolute position recorded at each landing position indicator is associated with a verified or unverified alignment of the elevator car with the landing doors at each landing.

According to some examples, there is provided an elevator installation system comprising: an elevator shaft comprising a plurality of landings, each landing comprising landing doors, a plurality of landing position indicators positioned within the elevator shaft, each landing position indicator corresponding to a landing; an elevator car arranged to move along the elevator shaft; an elevator drive arranged to move the elevator car; an absolute position reference system for detecting an absolute position of the elevator car in the elevator shaft; and an elevator controller, wherein the elevator controller is in communication with the elevator drive and the absolute position reference system; wherein the elevator controller commands the elevator drive to move the elevator car to a landing of the elevator shaft and to stop the elevator car at the landing; wherein an alignment of the elevator car with the landing doors of the given landing is checked when the elevator car is stopped; and wherein the elevator controller generates a landing table in which the absolute position is recorded at each landing position indicator, and is associated with a verified or unverified alignment of the elevator car with the landing doors at each landing.

The skilled person will therefore appreciate that the method and system described herein allow for the elevator system to simultaneously learn the location of the landings within the elevator shaft and verify the alignment of the elevator car with the landing doors at each landing (i.e. the levelling of the elevator car).

The elevator car is able to stop at the given landing by detection of the landing position indicator corresponding to the given landing. This is then associated with an absolute position of the elevator car within the elevator shaft, allowing for the elevator system to learn the location of each landing.

When the elevator car is stopped at a given landing, its alignment with the landing doors (e.g. alignment between the car doors of the elevator car and the landing doors) is checked. If the elevator car is properly aligned with the landing doors, the landing doors will open. This means that the elevator car is properly levelled with the given landing, and the landing position indicator is in the correct place, i.e. the landing has been verified. If the landing doors do not open, the landing position indicator is in an incorrect position, and therefore the landing is not verified.

A landing table is generated which comprises the absolute position of the elevator car at the given landing, and in which the absolute position recorded at each landing position indicator is associated with a verified or unverified alignment of the elevator car with the landing doors at each landing. This landing table is updated as the elevator car moves to each landing position indicator, i.e. each landing, allowing for incremental verification of the landing table.

In addition to one or more of the features described herein, or as an alternative, further examples may include the elevator car comprising car doors, and the method comprising checking an alignment of the car doors with the landing doors of the given landing.

In addition to one or more of the features described herein, or as an alternative, further examples may include that the elevator car comprises a levelling sensor for detecting the landing position indicator.

In addition to one or more of the features described herein, or as an alternative, further examples may include that the levelling sensor is able to communicate the detection of the landing position indicator, and communicate this to the elevator controller.

The elevator controller may be in communication with the elevator drive, and communicate to the elevator drive to stop driving the elevator car upon detection of the landing position indicator. The elevator controller may be programmed with an associated offset between the detected landing position indicator and the actual position of the landing relative to the elevator car, in order for the elevator drive to stop the car at the correct position relative to the landing.

In addition to one or more of the features described herein, or as an alternative, further examples may include that the landing position indicators are clips or stickers comprising unique patterns, e.g. optical or magnetic patterns. The optical patterns may include barcodes or QR codes. In some examples the levelling sensor comprises an optical sensor (e.g. a camera), wherein the levelling sensor is able to image the landing position indicator and determine which landing of the plurality of landings the elevator car has reached.

In addition to one or more of the features described herein, or as an alternative, further examples may include moving the landing position indicators associated with an unverified alignment of the elevator car with the landing doors at each landing.

Each landing position indicator may be moved manually. The new positioning of the landing position indicator may be determined from the absolute position reference data retrieved during verification of the landing.

In addition to one or more of the features described herein, or as an alternative, further examples may include further comprising repeating steps i)-vi) for the landings having an unverified alignment of the elevator car with the landing doors. In other words, the process is repeated for the moved landing position indicators, in order for the new position of these landing position indicators to be learned, and the alignment of the elevator car with the landing doors to be checked again for those ‘unverified’ landings.

In addition to one or more of the features described herein, or as an alternative, further examples may include updating the landing table with the absolute position recorded at each landing position indicator that has moved. This may allow for the landing table to be incrementally re-verified, for those landings which were previously unverified for alignment. This process of moving the landing position indicators, and re-verifying the landing table, may be repeated until alignment of the elevator car at every landing is verified.

The absolute position of the elevator car may be recorded using a suitable absolute position reference system connected to an elevator controller. The elevator controller may comprise a computer system including a processor and a memory. The absolute position of the elevator car may be recorded while the elevator car is moving, and/or when the elevator car is stopped at the landing.

In addition to one or more of the features described herein, or as an alternative, further examples may include recording the absolute position of the elevator car whilst the elevator car is moving. This may allow the position of the elevator car everywhere in the elevator shaft to be learned by the controller.

In addition to one or more of the features described herein, or as an alternative, further examples may include that the absolute position reference system comprises an absolute position reference tape, wherein the absolute position reference tape is positioned throughout the elevator shaft.

In addition to one or more of the features described herein, or as an alternative, further examples may include that an absolute position sensor reads the absolute position reference tape to determine the absolute position of the elevator car.

In addition to one or more of the features described herein, or as an alternative, further examples may include that the absolute position reference tape comprises a barcode tape. The barcode tape may be read by an optical sensor attached to the elevator car.

In addition to one or more of the features described herein, or as an alternative, further examples may include that the absolute position reference tape comprises a magnetic tape. The magnetic tape may be read by a magnetic sensor, e.g. an electromagnetic coil or a Hall effect sensor attached to the elevator car.

In addition to one or more of the features described herein, or as an alternative, further examples may include that the levelling sensor is combined with the absolute position sensor, for example as a single sensor assembly or even a single sensor. This may require the absolute position reference system to comprise an absolute position reference tape that is the same medium as the landing position indicators, e.g. they are both carrying barcodes.

In addition to one or more of the features described herein, or as an alternative, further examples may include that the absolute position sensor comprises a barometer.

In addition to one or more of the features described herein, or as an alternative, further examples may include that elevator car is moved from an uppermost landing of the elevator shaft to a lowest landing of the elevator shaft, and then from the lowest landing of the elevator shaft to the uppermost landing of the elevator shaft. Typically, an elevator shaft is built from bottom to top, e.g. from the lowest landing of the elevator shaft to the top level of the elevator shaft. When the hoistway is built, the elevator car is therefore at the uppermost landing of the elevator shaft, and so the verification process begins by moving the elevator car from the top of the elevator shaft.

In addition to one or more of the features described herein, or as an alternative, further examples may include that the elevator car is moving at a speed of approximately 0.3 m/s between the plurality of landings.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various examples of the present disclosure;

FIG. 2 is a schematic close-up illustration of an elevator car at a landing in such an elevator system;

FIG. 3 is a schematic diagram of a computing system in accordance with one or more examples of the present disclosure;

FIG. 4 is a flow diagram illustrating a method for verifying installation of an elevator system in accordance with one or more examples of the present disclosure; and

FIG. 5 is a floor table of the type generated by the method of FIG. 4.

### DETAILED DESCRIPTION OF THE INVENTION

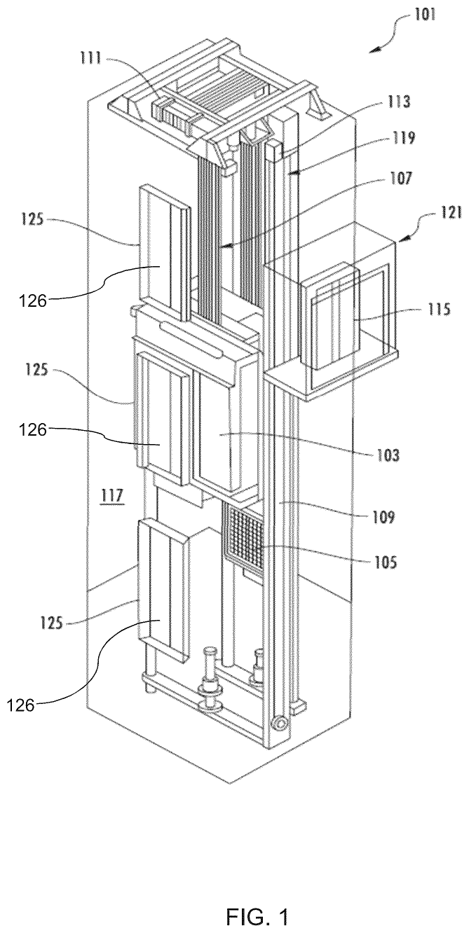

FIG. 1 is a perspective view of an elevator system 101 including an elevator car 103, a counterweight 105, a tension member 107, a guide rail 109, an elevator drive 111 and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the elevator drive 111, which is part of an overhead structure of the elevator system 101. The elevator drive 111 is configured to control movement between the elevator car 103 and the counterweight 105. The controller 115 is located, as shown, in a controller room 121 of the elevator shaft 117 and is configured to control the operation of the elevator system 101, and particularly the elevator car 103. For example, the controller 115 may provide drive signals to the elevator drive 111 to control the acceleration, deceleration, levelling, stopping, etc. of the elevator car 103. The controller 115 may also be configured to receive position signals from a position reference system or any other desired position reference device. When moving up or down within the elevator shaft 117 along guide rail 109, the elevator car 103 may stop at one or more landings 125 as controlled by the controller 115. Each landing 125 includes a set of landing doors 126 that open to allow passengers to enter and exit the elevator car 103. The landing doors 126 can open directly into the elevator car 103, or elevator doors integrally attached to the elevator car 103 may be coupled with the landing doors 126.

Although shown in a controller room 121, those of skill in the art will appreciate that the controller 115 can be located and/or configured in other locations or positions within the elevator system 101. In one example, the controller 115 may be located remotely or in a distributed computing network (e.g., cloud computing architecture). The controller 115 may be implemented using a processor-based machine, such as a personal computer, server, distributed computing network, etc.

The elevator drive 111 may include a motor or similar driving mechanism. In accordance with examples of the disclosure, the elevator drive 111 is configured to include an electrically driven motor. The power supply for the motor may be any power source, including a power grid, which, in combination with other components, is supplied to the motor. The elevator drive 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ examples of the present disclosure. Some examples may be employed in ropeless elevator systems using a linear motor (instead of the elevator drive 111) to impart motion to an elevator car. Examples may also be employed in ropeless elevator systems using a hydraulic lift (instead of the elevator drive 111) to impart motion to an elevator car. Examples may also be employed in ropeless elevator systems using self-propelled elevator cars (e.g., elevator cars equipped with friction wheels, pinch wheels or traction wheels). FIG. 1 is merely a non-limiting example presented for illustrative and explanatory purposes.

In elevator systems, such as that shown in FIG. 1, a position reference system is used to detect a position of the elevator car 103 along the elevator shaft 117 and relative to the landings 125. Such position reference systems are used to determine if the elevator car 103 is appropriately positioned relative to a landing 125 to allow opening of the landing doors 126 and enable loading/unloading of the elevator car 103, or whether the elevator car 103 is slightly above or below the landing 125 (i.e., a position offset). Landing door sensors can be provided to detect whether the landing doors 126 have opened successfully when the elevator car 103 is positioned at a landing 125.

Referring now to FIG. 2, an elevator position reference system 302 is shown in a side view illustration of an elevator car 103 located at a landing 125. Passengers can enter and/or exit the elevator car 103 when an elevator car door 127 is aligned with a landing door 126. Proper alignment (“levelling”) of the elevator car 103 with the landing 125 is desirable to prevent an offset such that a passenger may trip over a car sill 312 or a landing sill 314.

To ensure precise positioning of the elevator car 103 relative to the landing 125, the elevator system 300 includes an absolute position reference system 302. The absolute position reference system 302 includes at least one position sensor 316, 317 at the elevator car 103 and at least one position indicator 315, 318 within the elevator shaft 117. As illustrated in FIG. 2, the position sensors include a levelling sensor 316 and an absolute position sensor 317 is attached to or part of the elevator car 103. Specifically, in this example, the levelling sensor 316 is mounted to a car toe guard 320. The position sensors 316, 317 are movable with the elevator car 103. The position indicators 315, 318 are fixed within the elevator shaft 117. In this example, the position indicators include an absolute position reference tape 315 and a landing position indicator 318 fixed to a landing fascia 324 so as to correspond to the landing 125. There may be a landing position indicator 318 positioned at every landing 125 of the elevator shaft 117. The absolute position reference tape 315 can run continuously or repeatedly along the elevator shaft 117, e.g. so that the absolute position sensor 317 can provide the controller 115 with position information as the elevator car 103 travels between the landings 125.

In one example, the position sensors 316, 317 can include an active transmit sensor element and one or more passive receive sensor elements. In such an absolute position reference system 302, the position indicators 315, 318 can include one or more passive elements (e.g. barcode images, e.g. magnetic elements) that are interactive with the position sensor 316, 317 (e.g. camera, e.g. Hall Effect sensor) when the position sensor 316, 317 is located in proximity to the elements of the position indicator 315, 318. For example, the landing position indicators 318 can each be a barcode that is unique to the given landing 125 of the elevator system 101, which may be detected by the levelling sensor 316 (e.g. camera) to identify the landing. When the levelling sensor 316 is suitably aligned with the position indicator 318, the absolute position reference system 302 may send a signal to the elevator controller 115, and the elevator controller 115 may send a signal to stop the movement of the car 103, e.g. by pausing the elevator drive 111. Additionally, the absolute position reference system 302 may send a signal to the elevator controller 115, and the elevator controller 115 may send a signal to open the landing doors 126 (which can be coupled to the elevator car doors 127).

Alternatively, the absolute position reference system 302 may comprise different sensor types, such as contactless linear position sensors, for example photoelectric sensors or magnetic sensors, such as resonant inductive PCB coils, such that the system is able to detect when the elevator car 103 has reached a given landing.

In operation, as the elevator car 103 moves within the elevator shaft 117 relative to the landing 125, the levelling sensor 316 moves relative to the landing position indicator 318. The levelling sensor 316 may comprise an assembly of sensor elements, thus providing redundancy (where needed) and extended sensor stroke during landing identification.

The absolute position reference system 302 is arranged to detect the absolute position of the elevator car 103 relative to the elevator shaft 117. In the example shown in FIG. 2, there is an absolute position sensor 317 attached on the side of the elevator car 103 spaced from the landing 125. For example, the absolute position sensor 317 is adjacent to a wall of the elevator shaft 117 which is opposite to the landing 125. The absolute position sensor 317 may be an optical or magnetic sensor (e.g. camera), configured to read the absolute position reference (e.g. barcode, e.g. magnetic) tape 315 laid along the wall of the elevator shaft 117. The absolute position reference tape 315 may be laid along the full travelling path of the elevator car 103, allowing the absolute position sensor 317 to detect the height of the elevator car 103. In other examples, the absolute position sensor 317 and the levelling sensor 316 can be combined in a single (e.g. optical) sensor assembly. Alternatively, the absolute position sensor 317 may be any other suitable sensor, e.g. a barometer, which does not require the absolute position reference tape 315.

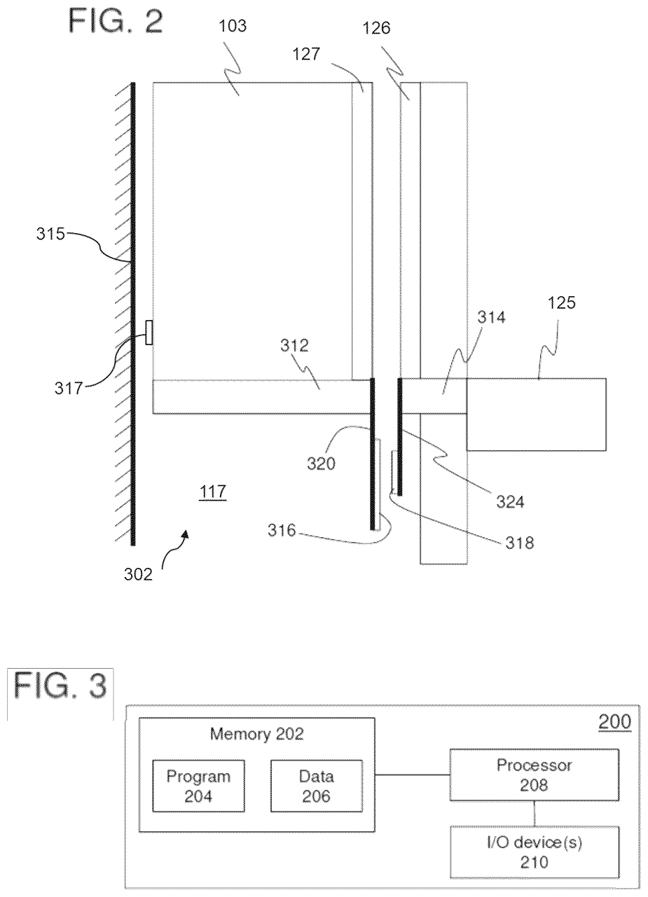

Referring now to FIG. 3, an example computing system 200 that can be incorporated into the elevator controller 115 for carrying out a method for verifying installation of an elevator system of the present disclosure is shown. The computing system 200 may be configured as part of and/or in communication with an elevator controller, e.g., controller 115 shown in FIG. 1. The computing system 200 includes a memory 202 which can store executable instructions as a program 204 and data 206 associated with the elevator system, such as landing information, elevator car position information, etc. The executable instructions can be stored or organized in any manner and at any level of abstraction, such as in connection with one or more applications, processes, routines, procedures, methods, etc.

As noted, the memory 202 may store data 206. The data 206 may include, but is not limited to, elevator car position data, elevator modes of operation, commands, or any other type(s) of data as will be appreciated by those of skill in the art. The instructions stored in the memory 202 may be executed by one or more processors, such as a processor 208. The processor 208 may be operative on the data 206.

The processor 208, as shown, is coupled to one or more input/output (I/O) devices 210. In some examples, the I/O devices 210 include external devices, such as the absolute position reference system 302 described above, to collect data and provide input into the processor 208 for processing (e.g., analyzing, storing, transmitting, etc.), and thus the processor 208 can receive signals from the absolute position reference system 302 (i.e., be in communication therewith). The I/O devices 210 may include sensors for detecting the status of the landing doors and car doors.

The processor 208 may receive data from the I/O devices, and communicate with the elevator controller 115 to move the elevator car up or down to a landing of the elevator shaft based on the received data. For example, if the processor 208 receives information from the levelling sensor on the elevator car that the elevator car has reached a landing, it may instruct the elevator controller 115 to stop the elevator car at the landing, and to open the landing doors.

The processor 208 may receive information from the absolute position sensor corresponding to the absolute position of the elevator car at the landing, and store this to the memory 202. The processor 208 may also receive information from the landing door sensors corresponding to whether the landing door sensors were able to open at the landing, and store this information to the memory 202 i.e. whether the elevator car was properly levelled with the landing to allow the landing doors to open.

After installation of an elevator system, the position of the landing position indicators 318 in the elevator shaft 117 must be verified, e.g. verifying that the landing doors 126 can open successfully when the levelling sensor 316 is aligned with the landing position indicator 318. Thus, a method for verifying installation of an elevator system is carried out before the elevator system is able to be used. This may be achieved by including an elevator installation verification program in the program 204 stored in the memory 202, executed by the processor 208 and output to the elevator controller 115.

The elevator installation verification program may instruct the elevator controller 115 to move the elevator car to each landing 125, record the absolute position of the elevator car 103, and check whether the landing doors 126 are able to open, such that the landing table may be updated at each landing.

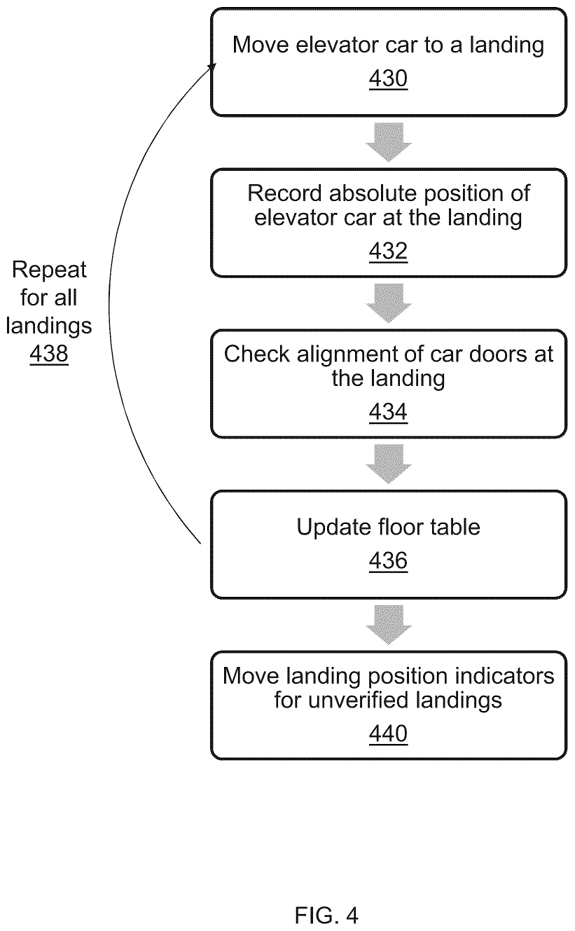

FIG. 4 shows a flow diagram of an elevator installation verification method which may be stored in the program 204 for verifying the installation of the elevator system.

At a first step 430, the elevator controller activates the elevator drive to move the elevator car to a given landing. The levelling sensor at the elevator car detects the landing position indicator associated with that landing, and the controller 115 stops the elevator car at the landing. Preferably, the elevator car starts at the bottom of the elevator shaft, and moves to a first lowermost landing.

At a second step 432, the absolute position sensor detects the absolute position of the elevator car in the elevator shaft at the given landing position indicator. This absolute position of the elevator car is recorded, and therefore associated with the given position indicator clip.

At a third step 434, the elevator controller instructs the elevator landing doors to open. The landing doors will only open if the elevator car is correctly aligned with the landing, i.e. the landing position indicator is positioned in the correct place in the elevator shaft for the elevator car to stop in the correct position where the bottom of the elevator car is level with the landing.

At a fourth step 436, the detected absolute position of the elevator car for the particular landing (i.e. at the landing position indicator) is recorded in a landing table. The status of the landing doors is also recorded in the landing table, where if the landing doors (e.g. at the front or rear of the elevator car) were able to open, the given landing is considered to be verified within the landing table. In some embodiments, the fourth step 436 may occur before the third step 434, or at the same time as the third step 434.

At a fifth step 438, the first, second, third, and fourth steps 430, 432, 434, and 436 are repeated for each landing in the elevator system, until the status of all landings in the elevator system are recorded in the landing table. Preferably, the elevator car is moved sequentially to a landing that is adjacent to the previous landing, to minimize travel time of the elevator car.

Using this method, the landing table is verified incrementally at each landing. At a sixth step 440, for any unverified landings, i.e. landings where any of the landing doors were not able to open, the corresponding landing position indicators are moved. The landing position indicator may be moved manually, to a new position where the landing doors may be able to open.

After the landing position indicators have been manually adjusted, the method may be repeated for the unverified landings. The elevator car is moved to each landing where the landing position indicators have been manually adjusted, and the landing table is updated. This process of verification and moving the landing position indicators is repeated until the landing table is fully verified.

When the landing table is fully verified, the controller is able to move the elevator car to any landing of the elevator system, i.e. move the car to any of the landing position indicators, and the elevator car will be correctly levelled with the landing such that the landings doors are able to open.

Therefore, the absolute position of the elevator car in the elevator shaft at each landing (i.e. at each landing position indicator) is learned at the same time as the ability of the landing doors to open at each landing is checked, allowing for the simultaneous learning of the elevator shaft and verification of the levelling of the elevator car. This may allow for the verification of the elevator system in a single run of the elevator car up (or down) the elevator shaft. This method allows for significant time to be saved during installation of the elevator compared to current methods for checking levelling of an elevator system, where the absolute position of the elevator relative to the landing position indicators would be learned in a different run to the checking of the landing doors. This may also allow for only previously unverified landings to be verified after the landing position indicators are moved, further saving time during installation compared to current methods for checking levelling of an elevator system, where all floors would have to be verified during every run, even those where position indicators have not been moved.

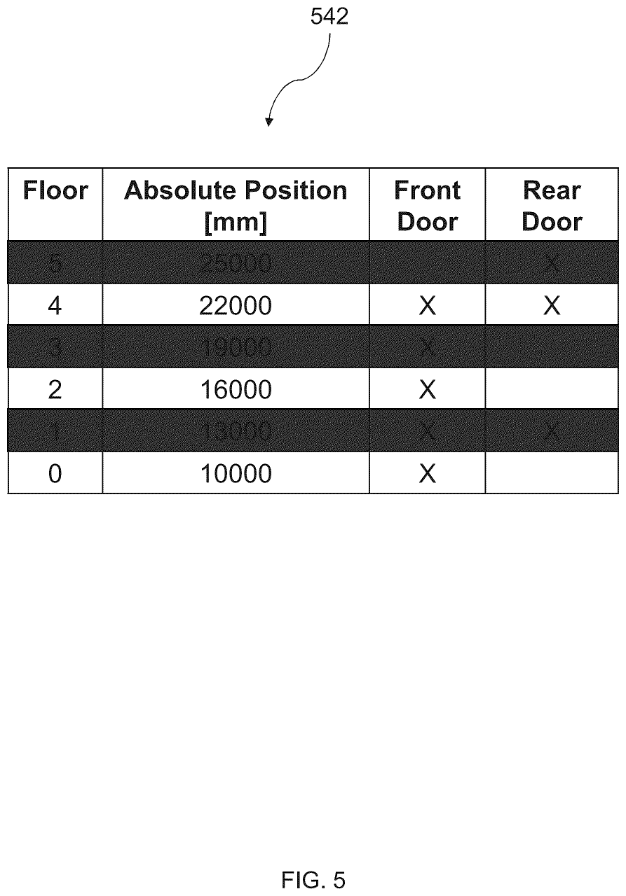

FIG. 5 shows an example of a landing table 542 generated using the method shown in FIG. 4. At each floor, an absolute position of the elevator car 103 within the shaft 117 is recorded, e.g. in millimeters from the bottom of the shaft 117.

The landing table 542 is for an elevator system 101 which comprises front landing doors and rear landing doors 126, allowing for passengers to enter/exit from two sides of the elevator car 103. In FIG. 2, the elevator position reference system 302 is for an elevator car 103 with one set of landing doors 126 at each floor. However, the elevator position reference system 302 may include both front and rear position sensors so as to detect two sets of landing position indicators corresponding to of the front and rear landing doors at each landing.

At each landing, the elevator controller 115 records the alignment of the front and rear landing doors. Verified landing doors are marked with an X, whilst unverified landing doors are unmarked. In this example, the front landing door at floor 5 did not open due to a misalignment, and the rear landing doors on floors 0, 2, and 3 did not open due to a misalignment. Therefore, the landing position indicators 318 corresponding to the front landing doors at floor 5, and the landing position indicators 318 corresponding to the rear landing doors at floors 0, 2, and 3 should be moved to a different absolute position within the elevator shaft. Once the landing position indicators for these landings have been moved, the elevator controller 115 then sends a signal to move the elevator car again to these landings, and re-check alignment of the landing doors at only the landings 0, 2, 3, and 5. The floor table may then be updated accordingly with the verification of alignment of these landing doors at each landing 0, 2, 3 and 5.

The term “about” is intended to include the degree of error associated with measurement of the particular quantity and/or manufacturing tolerances based upon the equipment available at the time of filing the application.

The terminology used herein is for the purpose of describing particular examples only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example examples are shown and described herein, each having certain features in the particular examples, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various examples of the present disclosure have been described, it is to be understood that aspects of the present disclosure may include only some of the described examples. Accordingly, the present disclosure is not to be seen as limited by the foregoing description, but is only limited by the scope of the appended claims.

What is claimed is:

1. A method for verifying installation of an elevator system, the elevator system comprising:
an elevator shaft (117) comprising a plurality of landings (125), each landing (125) comprising landing doors (126),
a plurality of landing position indicators (318) positioned within the elevator shaft (117), each landing position indicator (318) corresponding to a landing (125);
an elevator car (103) arranged to move along the elevator shaft (117);
an elevator drive (111) arranged to move the elevator car (103); and
an absolute position reference system (302) for providing an absolute position of the elevator car (103) in the elevator shaft (117);
the method comprising:
i) moving the elevator car (103) to a given landing (125) of the plurality of landings (125) and stopping at the given landing (125);
ii) recording the absolute position of the elevator car (103) at the landing position indicator (318) corresponding to the given landing (125);
iii) while the elevator car (103) is stopped at the given landing (125), checking for an alignment of the elevator car (103) with the landing doors (126) of the given landing (125);
iv) moving the elevator car (103) to another landing (125) of the plurality of landings (125) and stopping at the other landing (125);
v) repeating steps i)-iv) to move the elevator car (103) to each landing (125) of the plurality of landings (125); and
vi) generating a landing table (542) in which the absolute position recorded at each landing position indicator (318) is associated with a verified or unverified alignment of the elevator car (103) with the landing doors (126) at each landing (125).

2. The method of claim 1, further comprising moving the landing position indicator (318) associated with an unverified alignment with the landing doors (126) at each landing (125).

3. The method of claim 2, further comprising repeating steps i)-vi) for the landings (125) having an unverified alignment of the elevator car (103) with the landing doors (126).

4. The method of claim 3, comprising updating the landing table (542) with the absolute position recorded at each landing position indicator (318) that has been moved.

5. The method of claim 1, wherein the absolute position of the elevator car (103) is recorded whilst the elevator car (103) is moving.

6. The method of claim 1, wherein the elevator car (103) comprises a levelling sensor (316) for detecting the landing position indicators (318).

7. The method of claim 6, wherein each of the landing position indicators (318) comprises a unique pattern.

8. The method of claim 7, wherein the levelling sensor (316) comprises an optical sensor.

9. The method of claim 1, wherein the absolute position reference system (302) comprises an absolute position reference tape (315), wherein the tape (315) is positioned throughout the elevator shaft (115); and
an absolute position sensor (317) arranged to read the tape (315) to determine the absolute position of the elevator car (103).

10. The method of claim 9, wherein the absolute position reference tape (315) comprises a barcode tape.

11. The method of claim 9, wherein the absolute position reference tape (315) comprises a magnetic tape.

12. The method of claim 1, wherein the levelling sensor (316) is combined with the absolute position sensor (317).

13. The method of claim 1, wherein the elevator car (103) is moved from an uppermost landing (125) of the elevator shaft (117) to a lowest landing (125) of the elevator shaft (117), and then from the lowest landing (125) of the elevator shaft to the uppermost landing (125) of the elevator shaft (117).

14. The method of claim 1, wherein the elevator car (103) is moving at a speed of approximately 0.3 m/s between the plurality of landings (125).

15. An elevator installation system comprising:
an elevator shaft (117) comprising a plurality of landings (125), each landing (125) comprising landing doors (126),
a plurality of landing position indicators (318) positioned within the elevator shaft (117), each landing position indicator (318) corresponding to a landing (125);
an elevator car (103) arranged to move along the elevator shaft (117);
an elevator drive (111) arranged to move the elevator car (103);
an absolute position reference system (302) for detecting an absolute position of the elevator car (103) in the elevator shaft (117); and
an elevator controller (115), wherein the elevator controller (115) is in communication with the elevator drive (111) and the absolute position reference system (302);
wherein the elevator controller (115) commands the elevator drive (111) to move the elevator car (103) to a landing (125) of the elevator shaft (117) and to stop the elevator car (103) at the landing (125);
wherein an alignment of the elevator car (103) with the landing doors (126) of the given landing (125) is checked when the elevator car (103) is stopped; and
wherein the elevator controller (115) generates a landing table (542) in which the absolute position is recorded at each landing position indicator (318), and is associated with a verified or unverified alignment of the elevator car (103) with the landing doors (126) at each landing (125).
